(19) United States
(12) Patent Application Publication
(10) Pub. No.: US 2011/0282701 A1
(43) Pub. Date: Nov. 17, 2011

(54) Searching for Airline Travel Based Upon Seat Characteristics

(76) Inventor: Tim B. Reiz, Doral, FL (US)

(21) Appl. No.: 13/108,329

(22) Filed: May 16, 2011

Related U.S. Application Data
(60) Provisional application No. 61/345,010, filed on May 14, 2010.

(51) Int. Cl. G06Q 10/00; G06Q 30/00

(52) U.S. Cl. 705/5; 705/27.1

(57) ABSTRACT

A method for searching for airline travel based upon seat characteristics specified by a traveler is disclosed. Travel information is received indicating an origin, a destination, one or more travel dates and one or more seat characteristics other than class of service, all as specified by a traveler. Seat characteristics may include aisle, middle or window seat, bulkhead, row or seat number, individual view screen, power port access, etc. Flights meeting the origin, destination, and date(s) are identified, and then seat maps providing seat information and availability for the identified flights are retrieved. The seat information and identified flights are correlated to identify available seats having the specified seat characteristics, and pricing for those seats is then calculated. Information about the available seats having the specified seat characteristics and the pricing of those seats is then provided for display to a user to select a flight and seat for booking.

### CROSS-REFERENCE TO RELATED APPLICATIONS

This application claims the benefit of U.S. Provisional Patent Application No. 61/345,010 filed on May 14, 2010, and entitled “FLX FMS2 Airline Merchandising System,” which is incorporated herein by reference in its entirety.

### BACKGROUND

1. Field of the Invention

The present invention relates generally to the field of travel services. More specifically, the invention relates to methods for searching for and pricing airline travel based upon seat characteristics.

2. Prior Art

Some airline travelers wish to fly in seats having certain characteristics. For example, a traveler may want an aisle seat, a window seat, a bulkhead seat, a seat with an electric power outlet (“power port”), a seat having an individual view screen or Internet access, or even a specific row or seat number. It has traditionally been impossible to search directly for seats based upon such characteristics, and extremely difficult to even locate seats based upon such characteristics without a great deal of effort and without starting the booking process.

Prior to the advent of the internet, airline reservations were typically made either by calling an airline directly or by calling a travel agent. To compare airlines by schedule, a traveler had to either contact multiple airlines or review their printed schedules, consult a compendium of multiple schedules, the most common of which was known as the Official Airline Guide (“OAG”), or ask a travel agent to do so for the traveler. A traveler would typically then have to select a flight to find out whether the flight still had available seats and the pricing for the seats. In general, only after selecting or even booking the flight would the traveler be able to find out what specific seats were available on the flight and select one of them.

There are generally three classes or cabins that have been traditionally defined in airline travel, first class, business class and economy class. In some cases, airlines may give these classes different names, and certain aircraft or seat configurations on a particular aircraft may not have all three classes, but may provide only one or two classes. More recently, an economy class cabin may have a sub-class that provides greater leg room and is designated as “premium economy” or some other name. In addition to selecting a flight, it was also generally necessary to select the class of travel before determining what seats were available.

With the proliferation of the internet and web browsers, airlines have created websites that, among other features, allow users to view flight schedules, make their own reservations online directly with the airlines, and then select seats. This increased availability of flight information and the ability to book flights and select seats has caused many travelers to book their own flights without the use of conventional travel agents.

However, while travel agents have for many years typically had access to schedules and pricing information about multiple airlines, when the airlines first created their own websites it was necessary for a traveler to check each airline's website separately to obtain the schedule and pricing for that particular airline. Thus, a user looking for a flight between desired origin and destination cities had to visit all of the websites of the airlines that might fly between the airports in those cities, and perhaps even other nearby airports, in order to locate available flights and compare ticket prices, a time consuming process compared to a single call to a travel agent.

While individual airlines still provide their own websites, “aggregation” websites have been created that simplify the process of locating flights from different airlines. A first type of such aggregation website functions in a fashion similar to a travel agent, selling tickets on multiple airlines and collecting a commission from an airline when a ticket is sold; such sites include Expedia, Travelocity, and Orbitz. In some cases these sites can also locate and provide connections between flights from different airlines that individual airline sites may not show.

A second type of aggregation website collects and displays information from multiple airlines, and even from the first type of aggregation site, and then directs a traveler to the appropriate individual airline site or to an aggregation site of the first type to purchase a ticket. This second type of aggregation website includes such sites as Kayak (www.Kayak.com) or Bing Travel (www.bing.com/travel). Both types of aggregation sites can thus help travelers shorten the process of locating flights from multiple airlines.

While the OAG has evolved and now provides a website, a mobile application for use on a smart phone, and the ability to download updated airline schedules daily, it provides only overall schedule information, and does not show either seat availability or pricing. Thus, either the airlines or an aggregation website must be consulted to determine whether there are any seats available on specific flights and the pricing of those seats.

However, both the airlines' websites and the aggregation websites typically offer only limited searching capabilities that do not allow for any consideration of seat characteristics other than class, effectively similar to what was done before such websites were available. In general, to use such websites a traveler first specifies an origin city and destination city, a class of service, and a date or date range. (Some sites allow the traveler to request that other airports near the origin and/or destination be included.)

The user enters this information in the web browser window, and the information is then transmitted to the website, which searches for flights between the selected cities on the selected date(s), obtains prices for available flights, and returns a list of the available flights and prices for display to the traveler. To see what seats are available, the traveler must at least first select a single flight, and may even be required to begin the booking process in order to see available seats on that flight.

It is believed that while the airline and aggregation websites allow users to search for available flights and pricing information, none of them allow travelers to see available seats before a flight is selected, or to search for flights with available seats having certain characteristics other than only the class of travel.

### SUMMARY OF THE INVENTION

The present application describes a method for selecting airline travel based upon seat characteristics specified by a traveler.

In one embodiment, a computer-implemented method of making an airline reservation is disclosed, the method comprising the steps of receiving travel information at a first server indicating an origin, a destination, one or more travel dates, and one or more seat characteristics other than class of service all as specified by the traveler; identifying flights from the origin to the destination on the one or more travel dates; sending a request from the first server to a second server for seat information about the seat configuration and availability on the located flights; correlating the identified flights with the seat information to identify available seats having the specified seat characteristics; sending a request from the first server to a fourth server for pricing information on the available seats having the specified seat characteristics; and sending information about the available seats and the pricing information to a computing device for display.

In various embodiments, the first server searches information about flights that has been stored on the first server to identify specific flight routings from the origin to the destination on the one or more travel dates. In other embodiments, the first server sends a request to a third server for information about scheduled flights, and receives information from the third server identifying flight routings on one or more airlines, and uses the information received from the third server to construct flight routings from the origin to the destination according to an algorithm. The third server may be an airline server or a server having information about flights on a plurality of airlines.

In another embodiment, a non-transitory computer-readable medium has embodied thereon a program, the program being executable by a processor to perform a method of making an airline reservation, the method comprising the steps of receiving travel information at a first server indicating an origin, a destination, one or more travel dates, and one or more seat characteristics other than class of service all as specified by the traveler; identifying flights from the origin to the destination on the one or more travel dates; sending a request from the first server to a second server for seat information about the seat configuration and availability on the located flights; correlating the identified flights with the seat information to identify available seats having the specified seat characteristics; sending a request from the first server to a fourth server for pricing information on the available seats having the specified seat characteristics; and sending information about the available seats and the pricing information to a computing device for display.

### BRIEF DESCRIPTION OF THE DRAWINGS

FIG. 1 is an illustration of a network configuration 100 that might be used in methods of the prior art.

FIG. 2 illustrates one example of communication between a user and airline websites in the prior art.

FIG. 3 illustrates one example of communication between a user and an aggregation website in the prior art.

FIG. 4 illustrates one example of communication between a user and a website performing a search based upon seat characteristics according to one embodiment.

FIG. 5 is a flowchart of a method of searching for and pricing airline travel based upon seat characteristics according to one embodiment.

### DETAILED DESCRIPTION OF THE INVENTION

The present application describes a method for searching for and pricing airline travel based upon seat characteristics.

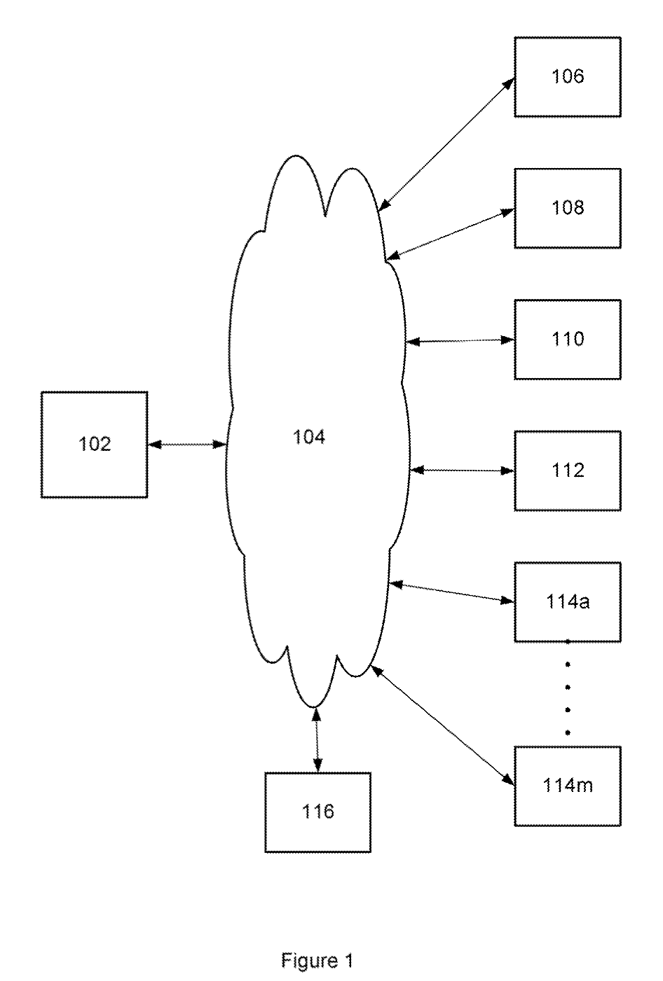

FIG. 1 is an illustration of a network configuration 100 that might be used in methods of the prior art. A user operates a device 102 having a web browser, for example, a computer, smartphone or other computing device, and which is connected to the internet 104. By using the device 102, the user is able to communicate across the internet 104 and access websites on remote servers 106 to 116.

As illustrated here, remote servers 106 and 108 host airline websites, while servers 110 and 112 host aggregation websites as described above. For example, server 106 might host the website of American Airlines, server 108 might host the website of United Airlines, server 110 might host the Travelocity website, and server 112 might host the Bing Travel website. Other servers 114a to 114m may host the websites of additional airlines, and servers 114n to 114z may host additional aggregation sites. Server 116 hosts the OAG website.

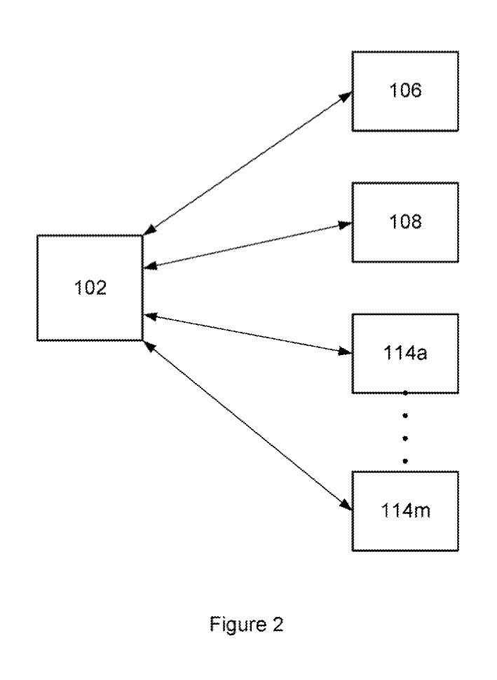

For purposes of illustration, FIGS. 2 to 4 show communications between computing device 102 and servers 106 to 116 in some prior art instances, and according to an embodiment described herein. While such communications occur over the internet 104, illustration of the internet has been removed in these figures for clarity so that the lines of communication between the user and various websites are visible.

FIG. 2 illustrates one example of how a user might access such websites in conventional systems. The user operates device 102, having a web browser, to access a plurality of airline websites located on remote servers 106, 108 and, for example, 114a to 114m. As above, to find all available flights to a specific destination, in this configuration a user must check each airline website separately. At each airline website, the user typically enters the desired origin and destination, possibly asking for nearby airports as well, a travel date or date range, and the desired class of service, i.e., first, business or economy. In some cases the user is asked to indicate whether a refundable or non-refundable fare is desired as well.

Each airline typically has software which receives the information provided by the user and accesses a database of flight information provided by the airline to determine what flights between the indicated points on the indicated date(s) in the selected class by that airline still have seats available for sale. (Airlines may also sometimes sell seats on other airlines in a “code share” practice, well known in the art.) When flights having seats remaining for sale are located, the airline software determines the pricing for those seats. A list of available flights, and the pricing on those flights, is then returned to be displayed to the user on device 102.

As is well known in the art, airlines practice “yield management,” seeking to maximize profit on each flight, and thus pricing may change on even an hourly basis, and is based on a number of factors, including the class of travel, how far in advance the ticket is purchased, whether the ticket is refundable or changeable without additional charge, etc. However, the pricing of seats is generally not based upon the specific characteristics of different seats within a class, and two passengers sitting in seats having the same characteristics may have paid widely varying fares.

Some airline websites will display only the cheapest fare on a given flight, while some will display the cheapest refundable fare as well as the cheapest non-refundable fare. Others may display the cheapest fares in classes other than the one indicated by the user. However, while there may be multiple fares in a single class such as economy, it is believed that all airline websites will only display the cheapest fare still available in the class.

(In the case of “premium economy,” the price is typically greater than the economy fare shown at this point, but not shown until after the user has selected the flight. Whether the user is given this option depends upon whether such seats are still available, and may also depend upon whether the indicated passenger is eligible for such seats, for example by having met certain frequent flyer qualifications.)

Thus, when a user views the available flights and fare prices, the user does not know which specific seats are still available or the characteristics of available seats other than class, but only that there are seats that are available on each of the indicated flights. It is generally only after the user has selected a flight from the display of available flights and prices that the user is able to select a specific seat. This may be done by the use of a seat map provided by the airline server for each specific flight.

The seat map will typically show all of the seats on the specific aircraft assigned to the flight, as well as such features as where the bulkheads and exits are located. In some cases, the seat map may show other features, such as whether and where there are power ports, etc. The seat map will also generally show what seats have already been assigned to passengers, thus allowing the user to see what seats are still available on that flight.

Again, however, the user must generally choose one of the displayed flights indicated as available for purchase in order to even be allowed to view the available seats on that flight. Also, in some cases the user may also be required to begin the booking process by, for example, either logging in with a frequent flyer number or providing the name of the passenger in order to view the seat map.

To check what seats are available on all flights from all airlines thus would require visiting multiple airline sites to search for all available flights from each airline, and on each site selecting each available flight one at a time and viewing the seat map for each flight. If there are a significant number of possible airlines and flights that meet the user's criteria, this is a very time consuming process. Further, by the time a user has checked a large number of airline sites and available flights, the availability and/or pricing of some flights may have already changed.

Further, in general the seat maps provided by the airlines for seat selection do not show many of the characteristics that may be desired by a traveler. While the seats are designated by number, and it is generally apparent whether a seat is an aisle, middle or window seat, in many maps it may not be apparent whether a seat is a bulkhead seat, or has a power port or individual view screen, for example.

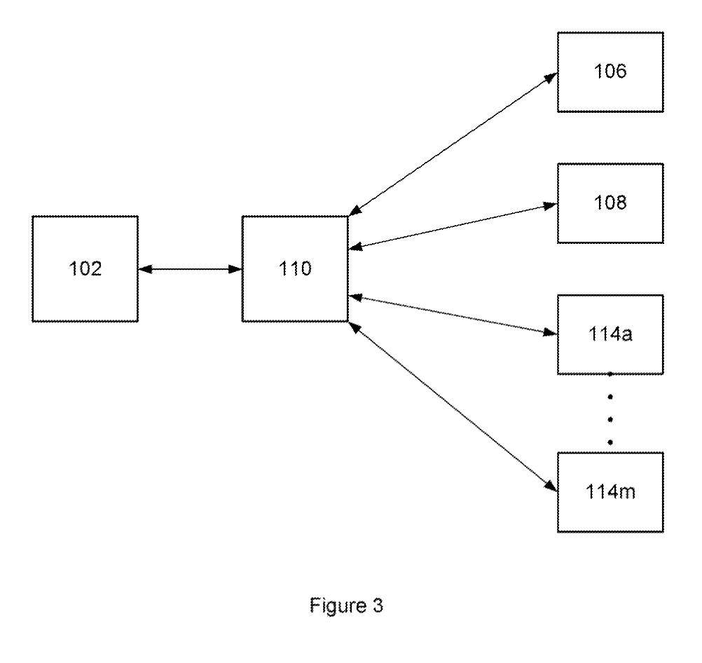

FIG. 3 shows how an aggregation site can at least make this process somewhat easier for the user. The user operates device 102 to access an aggregation site, here shown as the Travelocity site at server 110; however, any aggregation site as described above, such as Bing Travel at server 110 or Expedia, Orbitz, Kayak, etc. at servers 114n to 114z, will generally function in the same way. As with the individual airline sites, at the aggregation website the user typically enters the desired origin and destination and a travel date or date range, again possibly asking for nearby airports and/or a class of service as well.

The aggregation site in turn accesses the individual airline websites hosted on remote servers 106, 108 and 114a to 114m, and transmits the information received from the user to the airline websites. The airline sites receive the user information, perform a search and return information about the available flights and pricing on each airline as above. The aggregation site then receives the information from the individual airline websites about available flights and pricing, arranges it in some structured fashion, for example, in order of price or schedule, and displays the collected information to the user at device 102.

Thus, the benefit of using an aggregation site is that the user need not access all of the airline websites individually in order to locate available flights and pricing from multiple airlines but rather may obtain information about most airlines from a single search. (Since some airlines, for example Southwest Airlines, do not allow their data to be searched or collected by aggregation websites, however, it may still be necessary or desirable for the user to access those airlines' websites directly as otherwise some airlines that may fly the desired route may be missed.)

However, as with the individual airline sites, seat information is not initially provided, but only the fact that seats of a certain cabin class are available on the indicated flights at the indicated pricing. It is again at least necessary to select a flight to see a seat map. Further, some aggregation sites may not have direct access to the airlines' seat maps and may either show only a portion of the available seats or be unable to show available seats at all. In the latter case, it is generally again necessary to go directly to the website of the airline providing a desired flight in order to see the seat map for the flight.

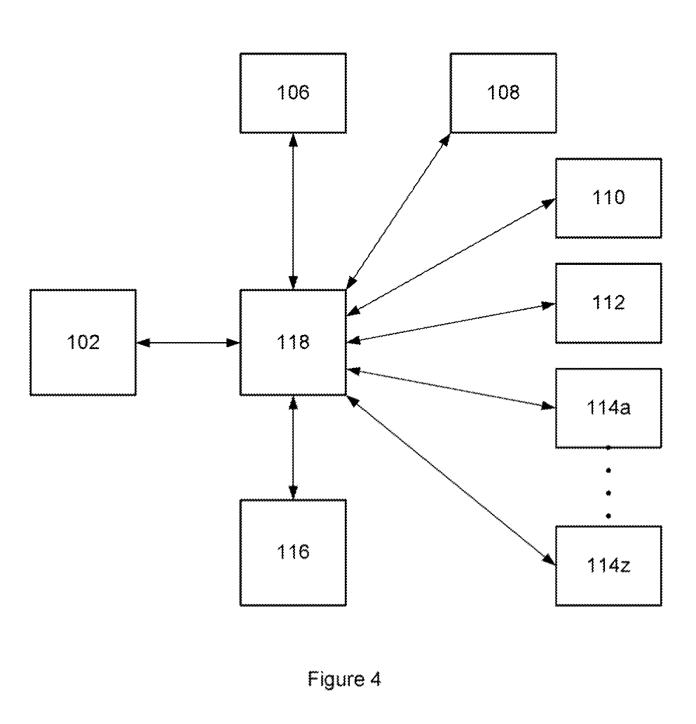

FIG. 4 illustrates one example of communication between a user and a website on which a software application performs a search based upon seat characteristics according to one embodiment. Similarly to the communication paths shown in FIG. 3, the user operates device 102 to access a server 118 which in turn accesses individual airline servers 106, 108 and 114a to 114m; however, the server 118 may also access aggregation sites hosted on servers 110, 112, and 114n to 114z. Server 118 also communicates with the OAG server 116 to receive a daily update of airline schedules from OAG.

As with an aggregation site, the user inputs travel information at device 102, including an origin and destination (indicating that nearby airports should be included if desired), a class of travel, and a travel date or date range. In addition, desired seat characteristics are specified, such as whether the seat is an aisle, middle or window seat or a bulkhead seat, whether it has a power port or individual view screen, etc.

However, the server 118 searches and returns results in a different way than aggregation sites as described with respect to FIG. 3. Server 118 is preloaded with both the daily OAG airline schedules and the airlines' pricing rules. Upon receiving the travel information, server 118 first checks the OAG schedule information for flights fitting the origin, destination, date(s) and class. In some instances, server 118 may also send a request to one or more individual airline servers 106, 108 and 114a to 114m to confirm or update the information from OAG. As with aggregation sites, server 118 may construct a routing by combining flights from an airline or from multiple airlines even though it is not returned as a complete routing by an airline in response to the request.

However, rather than now sending this information to the user as an aggregation site does, server 118 next sends a request to the airlines providing the identified flights for seat information for all of the identified flights or constructed routings, specifically what seats are available and their characteristics. Server 118 then compares the seat characteristics specified by the user to the seats shown as available to find seats that meet the specified characteristics. Only seats meeting the specified characteristics are then priced according to the airlines' pricing rules. The results are then sent to a user device for display to the user.

It will be apparent that this method has a number of benefits for a user. First, the method allows a user to automatically search for seats having desired characteristics and have the results returned substantially in real-time. It is not necessary for the user to select each flight in order to view a seat map (which as above may not even show all of the seat characteristics); rather, all available flights are searched at once and the results displayed together. Only seats meeting specified characteristics are displayed, so that the user need not waste time considering other seats.

Additionally, where there are multiple seats on a flight that fit the desired characteristics having different pricing, they may all be returned to the user for display. For example, as above there are seats that are not normally priced at this stage by airline sites or aggregation sites, such as premium economy. Both airline sites and aggregation sites typically return only available, economy fares and “upsell” premium economy seats later to those travelers who have already purchased a ticket and are qualified. However, such seats may be easily included in the described method. All that is necessary is that the software on server 118 contain appropriate rules to determine whether the passenger is permitted to purchase such a seat (e.g., has the requisite frequent flyer status) and what the pricing should be.

The form of the communications between the servers, and between server 118 and a user device, are well known in the art. Pricing information is often returned as reservation booking designators (“RBDs”) which contain single letters from A to Z to indicate a particular fare structure in a certain cabin class. For example, F and P typically designate first class, while Y, Q, S, and others designate economy class.

Similarly, seat information is generally transmitted in either an XML (Extensible Markup Language) format or an EDIFACT (United Nations Electronic Data Interchange For Administration, Commerce and Transport) format as is well known in the art. Requests for information may also be made in the EDIFACT format. Those of ordinary skill will appreciate the advantages and disadvantages of each, and of alternative ways in which information may be transmitted in the described method.

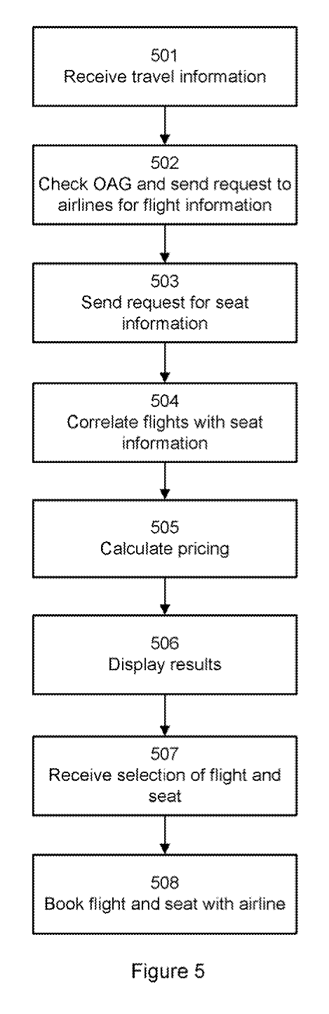

FIG. 5 shows a method for searching for and pricing airline travel based upon specified seat characteristics in one embodiment. At step 501, a server running an application as described herein receives travel information indicating an origin, a destination, one or more travel dates, and one or more desired seat characteristics other than class of service, all as specified by a traveler, although the class of service may be included as well. For example, the travel information may include a request for an aisle seat, a bulkhead seat, a seat having a power port or an individual view screen, etc.

At step 502, the server checks the received daily schedule from OAG and, if appropriate, sends a request to one or more airline servers to confirm or update information about flights on the airlines providing those flights between the desired points and on the desired date(s). As above, a complete routing may be available on a single airline, or the server may construct a routing from the received flight data according to a routing algorithm. Such a technique is well known to those of skill in the art.

Once flights are identified between the desired points on the desired date(s), at step 503 the server sends a request to the airlines providing the identified flights for seat information about the seat configuration on each identified flight, which seats are currently available, and the characteristics of the available seats.

At step 504, the seat information received is correlated with the identified flights and compared to the desired seat characteristics to identify which seats are currently available that meet the traveler's request. Once this is done, at step 505 pricing is calculated for the available seats that meet the characteristics contained in the traveler's request based upon the pricing rules of the airlines providing the flights. (The pricing rules are pre-loaded into the server.)

Once the pricing is calculated, at step 506 information about the available flights and the seats meeting the traveler's desired characteristics, and the pricing of such seats, for example in the form of a list, is sent to a computing device, such as the user device, for display. At step 507, a selection is received indicating the flight and seat that is to be booked for the traveler, and at step 508 the server sends booking information to the server of the airline providing the selected flight.

The disclosed method and apparatus has been explained above with reference to several embodiments. Other embodiments will be apparent to those skilled in the art in light of this disclosure. Certain aspects of the described method may readily be implemented using configurations or steps other than those described in the embodiments above, or in conjunction with elements other than or in addition to those described above.

For example, seat characteristics other than those enumerated herein may be used to search for seats. The user entering travel information, receiving the results, and selecting a flight and seat may be the actual traveler, or may be a representative of the traveler, for example, an administrative assistant or travel agent, or the parent, spouse or other relative of a traveler.

It should also be appreciated that the described method can be implemented in numerous ways, including as a process, a hard-wired logic apparatus, or a system. The methods described herein may be implemented by program instructions for instructing a processor to perform such methods, and such instructions recorded on a computer readable storage medium such as a hard disk drive, floppy disk, optical disc such as a compact disc (CD) or digital versatile disc (DVD), flash memory, etc. It should be noted that the order of the steps of the methods described herein may be altered and still be within the scope of the disclosure.

These and other variations upon the embodiments are intended to be covered by the present disclosure, which is limited only by the appended claims.

What is claimed is:

1. A computer-implemented method of searching for airline travel, comprising:
receiving travel information at a first server indicating an origin, a destination, one or more travel dates, and one or more seat characteristics other than class of service, all as specified by a traveler;
identifying flights from the origin to the destination occurring on the one or more travel dates;
sending a request from the first server to a second server for seat information about the seat configuration and availability on the identified flights;
correlating the identified flights with the seat information to identify available seats having the specified seat characteristics;
calculating pricing for the available seats having the specified seat characteristics based upon the pricing rules of the airlines providing the flights; and
sending information about the available seats and the pricing information to a computing device for display.

2. The method of claim 1 further comprising:
receiving a selection of an available seat; and
booking the selected flight and seat on behalf of the traveler with an airline providing the flight.

3. The method of claim 1 wherein identifying flights further comprises searching information about flights that has been stored on the first server to identify specific flight routings from the origin to the destination occurring on the one or more travel dates.

4. The method of claim 1 wherein identifying flights further comprises:
sending a request from the first server to a third server for information about scheduled flights;
receiving information from the third server identifying flight routings on one or more airlines; and
using the information received from the third server to construct flight routings from the origin to the destination according to an algorithm.

5. The method of claim 4 wherein sending a request from the first server to a third server for information about scheduled flights comprises sending the request to an airline server.

6. The method of claim 4 wherein sending a request from the first server to a third server for information about scheduled flights comprises sending the request to a server having information about flights on a plurality of airlines.

7. The method of claim 1 wherein the desired seat characteristics comprise whether the seat is an aisle, middle or window seat.

8. The method of claim 1 wherein the desired seat characteristics comprise whether the seat has a power port.

9. The method of claim 1 wherein the desired seat characteristics comprise a specific row number.

10. The method of claim 1 wherein the desired seat characteristics comprise a specific seat number.

11. The method of claim 1 wherein the desired seat characteristics comprise whether the seat has an individual view screen.

12. The method of claim 1 wherein the desired seat characteristics comprise whether the seat has internet access.

13. The method of claim 1 wherein the travel information includes a request to include airports within a predetermined radius of the desired origin and/or destination.

14. A non-transitory computer-readable medium having embodied thereon a program, the program being executable by a processor to perform a method of searching for airline travel, the method comprising the steps of:
receiving travel information at a first server indicating an origin, a destination, one or more travel dates, and one or more seat characteristics other than class of service, all as specified by a traveler;
identifying flights from the origin to the destination occurring on the one or more travel dates;
sending a request from the first server to a second server for seat information about the seat configuration and availability on the identified flights;
correlating the identified flights with the seat information to identify available seats having the specified seat characteristics;
calculating pricing for the available seats having the specified seat characteristics based upon the pricing rules of the airlines providing the flights; and
sending information about the available seats and the pricing information to a computing device for display.
